(19) United States
(12) Patent Application Publication
(10) Pub. No.: US 2004/0063011 A1
(43) Pub. Date: Apr. 1, 2004

(54) Imaging members

(75) Inventors: Liang-Bih Lin, Webster, NY (US); Merlin E. Scharfe, Penfield, NY (US); Harold F. Hammond, Rochester, NY (US); Cindy C. Chen, Rochester, NY (US); Richard H. Nealey, Plymouth, MA (US); Andronique Ioannidis, Webster, NY (US); Andrew R. Melnyk, Rochester, NY (US); Kenny-Tuan T. Dinh, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/253,826

(22) Filed: Sep. 24, 2002

(51) Int. Cl. G03G 5/047

(52) U.S. Cl. 430/57.3; 430/57.2; 430/58.25

(57) ABSTRACT

A photoconductive imaging member comprised of a supporting substrate, and thereover a single layer comprised of a mixture of a photogenerator component, a charge transport component, an electron transport component, and a polymer binder, and wherein the photogenerating component is a pigment.

### RELATED PATENT APPLICATIONS

Illustrated in copending application U.S. Ser. No. 09/302,524, the disclosure of which is totally incorporated herein by reference, is, for example, an ambipolar photoconductive imaging member comprised of a supporting substrate, and thereover a layer comprised of a photogenerator hydroxygallium component, a charge transport component, and an electron transport component.

Illustrated in copending application U.S. Ser. No. 09/627,283, the disclosure of which is totally incorporated herein by reference, is, for example, an imaging member comprising

a supporting layer and

an electrophotographic photoconductive insulating layer, the electrophotographic photoconductive insulating layer comprising

particles comprising Type V hydroxygallium phthalocyanine dispersed in a matrix comprising

an arylamine hole transporter, and

an electron transporter selected from the group consisting of

N,N′-bis(1,2-dimethylpropyl)-1,4,5,8-naphthalenetetracarboxylic diimide represented by:

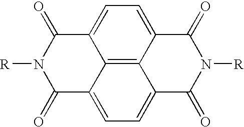

1,1′-dioxo-2-(4-methylphenyl)-6-phenyl-4-(dicyanomethylidene)thiopyran represented by:

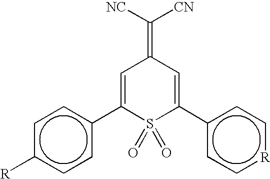

wherein each R is independently selected from the group consisting of hydrogen, alkyl having 1 to 4 carbon atoms, alkoxy having 1 to 4 carbon atoms and halogen, and

a quinone selected from the group consisting of

carboxybenzylnaphthaquinone represented by:

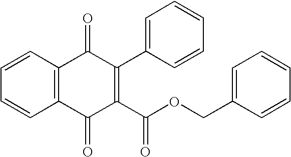

and ter(t-butyl) diphenolquinone represented by:

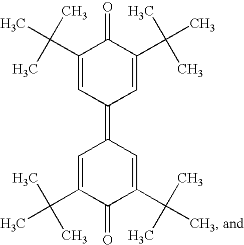

mixtures thereof, and a film forming binder.

The appropriate components and processes of the above copending applications may be selected for the invention of the present application in embodiments thereof.

### BACKGROUND

This invention relates in general to electrophotographic imaging members and, more specifically, to positively and negatively charged electrophotographic imaging members having two or more layers containing both charge generation and transport functions and processes for forming images on the member. More specifically, the present invention relates to a photoconductive imaging member having two layers wherein the first layer contains a greater concentration of photo-electrically active pigments than the second layer. The electrophotographic imaging member, dual layer components, which can be dispersed in various suitable resin binders, can be of various thickness, however, in embodiments the thickness of the combined dual layers can be, for example, from about 5 to about 60 microns, and more specifically from about 10 to about 40 microns with each layer of about equal thickness. The layers can be considered dual function layers since they can generate charge and transport charge over a wide distance, such as a distance of at least about 50 microns

Many electrophotographic imaging members are multi-layered imaging members comprising a substrate and a plurality of other layers such as a charge generating layer and a charge transport layer. These commercial multi-layered imaging members also often contain a charge blocking layer and an adhesive layer between the substrate and the charge generating layer. Further, an anti-plywooding layer may be needed. This anti-plywooding layer can be a separate layer or be part of a dual function layer. An example of a dual function layer for preventing plywooding is a charge blocking layer or an adhesive layer which also prevents plywooding. The expression “plywooding”, as employed herein, refers in embodiments to the formation of unwanted patterns in electrostatic latent images caused by multiple reflections during laser exposure of a charged imaging member. When developed, these patterns resemble plywood. These multi-layered imaging members are also costly and time consuming to fabricate because of the many layers that must be formed. Further, complex equipment and valuable factory floor space are required to manufacture these multi-layered imaging members. In addition to presenting plywooding problems, the multi-layered imaging members often encounter charge spreading which degrades image resolution.

Another problem encountered with multilayered photoreceptors comprising a charge generating layer and a charge transport layer is that the thickness of the charge transport layer, which is normally the outermost layer, tends to become thinner due to wear during image cycling. The change in thickness causes changes in the photoelectrical properties of the photoreceptor. Attempts have been made to fabricate electrophotographic imaging members comprising a substrate and a single electrophotographic photoconductive insulating layer in place of a plurality of layers such as a charge generating layer and a charge transport layer. However, in formulating single electrophotographic photoconductive insulating layer photoreceptors many problems need to be overcome including charge acceptance for hole and/or electron transporting materials from photoelectroactive pigments. In addition to electrical compatibility and performance, a material mix for forming a single layer photoreceptor should possess the proper rheology and resistance to agglomeration to enable acceptable coatings. Also, compatibility among pigment, hole and electron transport molecules, and film forming binder is desirable. However, the top photogeneration also means that for a single layer photoreceptor with an end-of-life thickness of 60% of its initial thickness, only pigments in the top half of a single layer photoreceptor are really being used, the rest of the pigments may be in fact impeding the charge transport and causing a high dark decay. To resolve these issues, we invented differential composite photoreceptors, photoreceptors containing two dual functionality layers with the first layer having a higher pigment loading than that of the second layer have proven beneficial.

### REFERENCES

U.S. Pat. No. 4,265,990 discloses a photosensitive member having at least two electrically operative layers. The first layer comprises a photoconductive layer which is capable of photogenerating holes and injecting photogenerated holes into a contiguous charge transport layer. The charge transport layer comprises a polycarbonate resin containing from about 25 to about 75 percent by weight of one or more of a compound having a specified general formula. This structure may be imaged in the conventional xerographic mode which usually includes charging, exposure to light and development.

U.S. Pat. No. 5,336,577 disclosing a thick organic ambipolar layer on a photoresponsive device is simultaneously capable of charge generation and charge transport. In particular, the organic photoresponsive layer contains an electron transport material such as a fluorenylidene malonitrile derivative and a hole transport material such as a dihydroxy tetraphenyl benzadine containing polymer. These may be complexed to provide photoresponsivity, and/or a photoresponsive pigment or dye may also be included.

The entire disclosures of these patents are incorporated herein by reference.

### SUMMARY

Disclosed is an electrophotographic imaging member comprising a first and second electrophotographic layer that avoids plywooding problems, and which layers contain a photogenerating pigment, an electron transport component, a hole transport component, and a film forming binder.

Also disclosed is an electrophotographic imaging member comprising a first and second electrophotographic layer that eliminates the need for a charge blocking layer between a supporting substrate and an electrophotographic photoconductive insulating layer, and wherein the photogenerating mixture layer can be of a thickness of, for example, from about 5 to about 60 microns,

Further disclosed is an electrophotographic imaging member comprising a first and second electrophotographic layer which can be fabricated with fewer coating steps at a reduced cost.

Also disclosed is an electrophotographic imaging member comprising a first and second electrophotographic layer which has improved cycling and stability.

Further disclosed is an electrophotographic imaging member comprising a first and second two electrophotographic layer for which PIDC curves do not substantially change with time or repeated use, and also wherein with these photoreceptors charge injections from the substrate to the photogenerating pigment is reduced and thus a charge blocking layer can be avoided.

Still further disclosed is an electrophotographic imaging member comprising a first and second two electrophotographic layer which is ambipolar and can be operated at either positive or negative biases.

The present invention in embodiments thereof is directed to a photoconductive imaging member comprised of a supporting substrate, at least two layers thereover comprised of a mixture of a photogenerating pigment or pigments, a hole transport component or components, an electron transport component or components, and a film forming binder, and wherein the first layer has a greater photo-electrically active pigment concentration than the second layer. Aspects of the present invention are directed to a photoconductive imaging member comprised in sequence of a substrate, a first and second electrophotographic layer, the electrophotographic comprising photogenerating particles comprising photogenerating pigments, such as metal free phthalocyanines, dispersed in a matrix comprising a hole transport molecule such as, for example, those selected from the group consisting of an arylamine and a hydrazone, and an electron transport material, for example, selected from the group consisting of a carboxlfluorenone malonitrile (CFM) derivatives represented by:

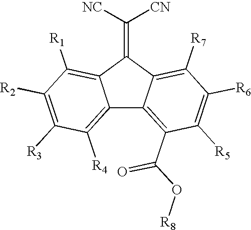

wherein each R is independently selected from the group consisting of hydrogen, alkyl having 1 to 40 carbon atoms, alkoxy having 1 to 40 carbon atoms, phenyl, substituted phenyl, higher aromatics, for example, naphthalene and antracene, alkylphenyl having 6 to 40 carbons, alkoxyphenyl having 6 to 40 carbons, aryl having 6 to 30 carbons, substituted aryl having 6 to 30 carbons and halogen,

or a nitrated fluoreneone derivative represented by:

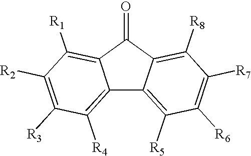

wherein each R is independently selected from the group consisting of hydrogen, alkyl having 1 to 40 carbon atoms, alkoxy having 1 to 40 carbon atoms, phenyl, substituted phenyl, higher aromatics, for example, naphthalene and antracene, alkylphenyl having 6 to 40 carbons, alkoxyphenyl having 6 to 40 carbons, aryl having 6 to 30 carbons, substituted aryl having 6 to 30 carbons and halogen, and at least 2 R groups are chosen to be nitro groups,

or a N,N′bis(dialkyl)-1,4,5,8-naphthalenetetracarboxylic diimide derivative or N,N′bis(diaryl)-1,4,5,8-naphthalenetetracarboxylic diimide derivative represented by:

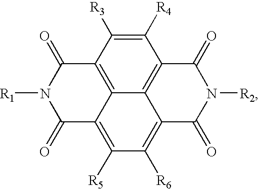

wherein R1 is substituted or unsubstituted alkyl, branched alkyl, cycloalkyl, alkoxy or aryl, such as phenyl, naphthyl, or a higher polycyclic aromatics, for example, anthracene R2 is alkyl, branched alkyl, cycloalkyl, or aryl, such as phenyl, naphthyl, or a higher polycyclic aromatic such as anthracene or the same as R1; R1 and R2 can be chosen independently to have total carbon number from about 1 to about 50 but in embodiments from about 1 to about 12. R3, R4, R5 and R6 are alkyl, branched alkyl, cycloalkyl, alkoxy or aryl, such as phenyl, naphthyl, or a higher polycyclic aromatic such as anthracene or halogen and the like. R3, R4, R5 and R6 can be the same or different. In the case were R3, R4, R5 and R6 are carbon, they can be chosen independently to have a total carbon number between 1 and 50 but is preferred to be from about 1 to about 12,

or a 1,1′-dioxo-2-(aryl)-6-phenyl-4-(dicyanomethylidene)thiopyran derivative represented by:

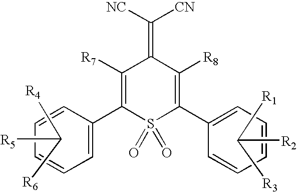

wherein each R is independently selected from the group consisting of hydrogen, alkyl having 1 to 40 carbon atoms, alkoxy having 1 to 40 carbon atoms, phenyl, substituted phenyl, higher aromatic for example naphthalene and antracene, alkylphenyl having 6 to 40 carbons, alkoxyphenyl having 6 to 40 carbons, aryl having 6 to 30 carbons, substituted aryl having 6 to 30 carbons and halogen,

or a

carboxybenzylnaphthaquinone derivative represented by:

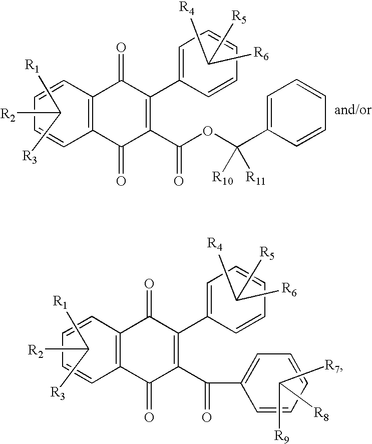

wherein each R is independently selected from the group consisting of hydrogen, alkyl having 1 to 40 carbon atoms, alkoxy having 1 to 40 carbon atoms, phenyl, substituted phenyl, higher aromatics, for example, naphthalene and antracene, alkylphenyl having 6 to 40 carbons, alkoxyphenyl having 6 to 40 carbons, aryl having 6 to 30 carbons, substituted aryl having 6 to 30 carbons and halogen, or a diphenoquinone represented by:

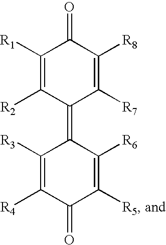

mixtures thereof, wherein each R is independently selected from the group consisting of hydrogen, alkyl having 1 to 40 carbon atoms, alkoxy having 1 to 40 carbon atoms, phenyl, substituted phenyl, higher aromatics, for example naphthalene and antracene, alkylphenyl having 6 to 40 carbons, alkoxyphenyl having 6 to 40 carbons, aryl having 6 to 30 carbons, substituted aryl having 6 to 30 carbons and halogen, and a film forming binder, and wherein the first layer has a greater photo-electrically active pigment concentration than the second layer.

This imaging member may be imaged by depositing a uniform electrostatic charge on the imaging member, exposing the imaging member to activating radiation in image configuration to form an electrostatic latent image, and developing the latent image with electrostatically attractable marking particles to form a toner image in conformance to the latent image.

Any suitable substrate may be employed in the imaging member of this invention. The substrate may be opaque or substantially transparent, and may comprise any suitable material having the requisite mechanical properties. Thus, for example, the substrate may comprise a layer of insulating material including inorganic or organic polymeric materials, such as MYLAR® a commercially available polymer, MYLAR® coated titanium, a layer of an organic or inorganic material having a semiconductive surface layer, such as indium tin oxide, aluminum, titanium and the like, or exclusively be comprised of a conductive material such as aluminum, chromium, nickel, brass and the like. The substrate may be flexible, seamless or rigid and may have a number of many different configurations, such as, for example, a plate, a drum, a scroll, an endless flexible belt, and the like. In one embodiment, the substrate is in the form of a seamless flexible belt. The back of the substrate, particularly when the substrate is a flexible organic polymeric material may optionally be coated with a conventional anticurl layer. Examples of substrate layers selected for the imaging members of the present invention can be as indicated herein, such as an opaque or substantially transparent material, and may comprise any suitable material having the requisite mechanical properties. Thus, the substrate may comprise a layer of insulating material including inorganic or organic polymeric materials, such as MYLAR® a commercially available polymer, MYLAR® containing titanium, or other suitable metal, a layer of an organic or inorganic material having a semiconductive surface layer, such as indium tin oxide, or aluminum arranged thereon, or a conductive material inclusive of aluminum, chromium, nickel, brass and the like. The thickness of the substrate layer as indicated herein depends on many factors, including economical considerations, thus this layer may be of substantial thickness, for example over 3,000 microns, or of a minimum thickness. In one embodiment, the thickness of this layer is from about 75 microns to about 300 microns.

Generally, the thickness of the two layers in contact with the supporting substrate depends on a number of factors, including the thickness of the substrate, and the amount of components contained in each of the two layers, and the like. Accordingly, the layers can be of a thickness of, for example, from about 3 microns to about 60 microns, and more specifically, from about 5 microns to about 30 microns. The maximum thickness of the layer in an embodiment is dependent primarily upon factors, such as photosensitivity, electrical properties and mechanical considerations.

The binder resin present in various suitable amounts, for example from about 5 to about 70, and more specifically, from about 10 to about 50 weight percent, may be selected from a number of known polymers such as poly(vinyl butyral), poly(vinyl carbazole), polyesters, polycarbonates, poly(vinyl chloride), polyacrylates and methacrylates, copolymers of vinyl chloride and vinyl acetate, phenoxy resins, polyurethanes, poly(vinyl alcohol), polyacrylonitrile, polystyrene, and the like. In embodiments of the present invention, it is desirable to select as the first and second layer coating solvents, such as ketones, alcohols, aromatic hydrocarbons, halogenated aliphatic hydrocarbons, ethers, amines, amides, esters, and the like. Specific binder examples are cyclohexanone, acetone, methyl ethyl ketone, methanol, ethanol, butanol, amyl alcohol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like.

An optional adhesive layer may be formed on the substrate. Typical materials employed in an undercoat adhesive layer include, for example, polyesters, polyamides, poly(vinyl butyral), poly(vinyl alcohol), polyurethane and polyacrylonitrile, and the like. Typical polyesters include, for example, VITEL® PE100 and PE200 available from Goodyear Chemicals, and MOR-ESTER 49,000® available from Norton International. The undercoat layer may have any suitable thickness, for example, of from about 0.001 micrometers to about 10 micrometers. A thickness of from about 0.1 micrometers to about 3 micrometers can be desirable. Optionally, the undercoat layer may contain suitable amounts of additives, for example, of from about 1 weight percent to about 10 weight percent, of conductive or nonconductive particles, such as zinc oxide, titanium dioxide, silicon nitride, carbon black, and the like, to enhance, for example, electrical and optical properties. The undercoat layer can be coated onto a supporting substrate from a suitable solvent. Typical solvents include, for example, toluene, tetrahydrofuran, dichloromethane, and the like, and mixtures thereof.

The positively charged, or negatively charged photoresponsive imaging member of the present invention in embodiments is comprised, in the following sequence, of a supporting substrate, at least two layers thereover comprised of a photogenerator layer selected from the group consisting of, charge transport molecules of N,N′-diphenyl-N,N′-bis(3-methyl phenyl)-1,1′-biphenyl-4,4′-diamine, hydroxy gallium phthalocyanine, poly (4,4′-diphenyl-11′-cyclohexane carbonate), N,N′bis(1,2-dimethylpropyl)-1,4,5,8-naphthalenetetracarboxylic diimide. and electron transport components of (4-n-butoxycarbonyl-9-fluorenylidene) malononitrile all dispersed in a suitable polymer binder, such as a polycarbonate binder.

Examples of photogenerating components, especially pigments are metal free phthalocyanines, and as an optional second pigment metal phthalocyanines, perylenes, vanadyl phthalocyanine, chloroindium phthalocyanine, and benzimidazole perylene, which is preferably a mixture of, for example, 60/40, 50/50, 40/60, bisbenzimidazo(2,1-a-1′,2′-b)anthra(2,1,9-def:6,5,10-d′e′f′) diisoquinoline-6,11-dione and bisbenzimidazo(2,1-a:2′,1′-a)anthra(2,1,9-def:6,5,10-d′e′f′)diisoquinoline-10,21-dione, and the like, inclusive of appropriate known photogenerating components.

Charge transport components that may be selected for the photogenerating mixture include, for example, N,N′bis(1,2-dimethyl propyl)-1,4,5,8-naphthalenetetracarboxylic diimide, N,N′-diphenyl-N,N-bis(3-methyl phenyl)-1,1′-biphenyl-4,4′-diamine, 9-9-bis(2-cyanoethyl)-2, 7-bis(phenyl-m-tolylamino)fluorene, tritolylamine, hydrazone, N,N′-bis(3,4 dimethylphenyl)-N″(1-biphenyl) amine and the like, dispersed in a polycarbonate binder.

Specific examples of electron transport molecules are (4-n-butoxycarbonyl-9-fluorenylidene)malononitrile, 2-methylthioethyl 9-dicyano methylenefluorene-4-carboxylate, 2-(3-thienyl)ethyl 9-dicyano methylenefluorene-4-carboxylate, 2-phenylthioethyl 9-dicyano methylenefluorene-4-carboxylate, 11,11,12,12-tetracyano anthraquino dimethane, 1,3-dimethyl-10-(dicyanomethylene)-anthrone, and the like.

The photogenerating pigment can be present in various amounts, such as, for example, from about 0.05 weight percent to about 30 weight percent, and more specifically, from about 0.05 weight percent to about 5 weight percent. Charge transport components, such as hole transport molecules, can be present in various effective amounts, such as in an amount of from about 10 weight percent to about 75 weight percent and preferably in an amount of from about 30 weight percent to about 50 weight percent; the electron transport molecule can be present in various amounts, such as in an amount of from about 10 weight percent to about 75 weight percent, and more specifically, in an amount of from about 5 weight percent to about 30 weight percent, and the polymer binder can be present in an amount of from about 10 weight percent to about 75 weight percent, and more specifically, in an amount of from about 30 weight percent to about 50 weight percent. The combined thickness of the first and second dual functionality composite layer can be, for example, from about 5 microns to about 60 microns, and more specifically, from about 10 microns to about 30 microns.

The photogenerating pigment primarily functions to absorb the incident radiation and generates electrons and holes. In a negatively charged imaging member, holes are transported to the photoconductive surface to neutralize negative charge and electrons are transported to the substrate to permit photodischarge. In a positively charged imaging member, electrons are transported to the surface where they neutralize the positive charges and holes are transported to the substrate to enable photodischarge. By selecting the appropriate amounts of charge and electron transport molecules, ambipolar transport can be obtained, that is, the imaging member can be charged negatively or positively charged, and the member can also be photodischarged.

The photoconductive imaging members can be prepared by a number of methods, such as the coating of the components from a dispersion, and more specifically, as illustrated herein. Thus, the photoresponsive imaging members of the present invention can in embodiments be prepared by a number of known methods, the process parameters being dependent, for example, on the member desired. The photogenerating, electron transport, and charge transport components of the imaging members can be coated as solutions or dispersions onto a selective substrate by the use of a spray coater, dip coater, extrusion coater, roller coater, wire-bar coater, slot coater, doctor blade coater, gravure coater, and the like, and dried at from about 40 degrees centigrade to about 200 degrees centigrade for a suitable period of time, such as from about 10 minutes to about 10 hours, under stationary conditions or in an air flow. The coating can be accomplished to provide a final coating thickness of from about 5 to about 40 microns after drying.

Imaging members of the present invention are useful in various electrostatographic imaging and printing systems, particularly those conventionally known as xerographic processes. Specifically, the imaging members of the present invention are useful in xerographic imaging processes wherein the photogenerating component absorbs light of a wavelength of from about 550 to about 950 nanometers, and in embodiments from about 700 to about 850 nanometers. Moreover, the imaging members of the present invention can be selected for electronic printing processes with gallium arsenide diode lasers, light emitting diode (LED) arrays which typically function at wavelengths of from about 660 to about 830 nanometers, and for color systems inclusive of color printers, such as those in communication with a computer. Thus, included within the scope of the present invention are methods of imaging and printing with the photoresponsive or photoconductive members illustrated herein. These methods generally involve the formation of an electrostatic latent image on the imaging member, followed by developing the image with a toner composition comprised, for example, of thermoplastic resin, colorant, such as pigment, charge additive, and surface additives, reference U.S. Pat. Nos. 4,560,635; 4,298,697 and 4,338,390, the disclosures of which are totally incorporated herein by reference, subsequently transferring the image to a suitable substrate, and permanently affixing, for example by heat, the image thereto. In those environments wherein the member is to be used in a printing mode, the imaging method is similar with the exception that the exposure step can be accomplished with a laser device or image bar.

Electron transport material examples include 2-methylthioethyl 9-dicyanomethylenefluorene-4-carboxylate, 2-(3-thienyl)ethyl 9-dicyano methylenefluorene-4-carboxylate, a 2-phenylthioethyl 9-dicyano methylenefluorene-4-carboxylate, and the like. The electron transporting materials can contribute to the ambipolar properties of the final photoreceptor and also provide the desired rheology and freedom from agglomeration during the preparation and application of the coating dispersion. Moreover, these electron transporting materials ensure substantial discharge of the photoreceptor during imagewise exposure to form the electrostatic latent image.

Polymer binder examples include components, as illustrated, for example, in U.S. Pat. No. 3,121,006, the disclosure of which is totally incorporated herein by reference. Specific examples of polymer binder materials include polycarbonates, acrylate polymers, vinyl polymers, cellulose polymers, polyesters, polysiloxanes, polyamides, polyurethanes and epoxies as well as block, random or alternating copolymers thereof. Preferred electrically inactive binders are comprised of polycarbonate resins with a molecular weight of from about 20,000 to about 100,000, and more specifically, with a molecular weight, of from about 50,000 to about 100,000.

The combined weight of the arylamine hole transport molecules and the electron transport molecules in the electrophotographic photoconductive insulating layer is between about 35 percent and about 65 percent by weight, based on the total weight of the electrophotographic photoconductive insulating layer after drying. The film forming polymer binder can be present in an amount of from about 10 weight percent to about 75 weight percent, and in embodiments in an amount of from about 30 weight percent to about 60 weight percent, based on the total weight of the first and second electrophotographic layer after drying. The hole transport and electron transport molecules are dissolved or molecularly dispersed in the film forming binder. The expression “molecularly dispersed”, as employed herein, is defined as dispersed on a molecular scale. The above materials can be processed into a dispersion useful for coating by any of the conventional methods used to prepare such materials. These methods include ball milling, media milling in both vertical or horizontal bead mills, paint shaking the materials with suitable grinding media, and the like to achieve a suitable dispersion.

The following Examples are provided.

### EXAMPLE I

A pigment dispersion was prepared by ball milling 5 grams of Type V hydroxygallium phthalocyanine pigment particles and 5 grams of poly(4,4′-diphenyl-1,1′-cyclohexane carbonate) [PCZ400, available from Mitsubishi Gas Chemical Co., Inc.] binder in 41 grams of tetrahydrofuran (THF) with five hundred fifty grams of 3 millimeter diameter steel balls for 58 hours. Separately, 120 grams of poly(4,4′-diphenyl-1,1′-cyclohexane carbonate) was weighed along with 78 grams of N,N′-diphenyl-N,N′-bis(methylphenyl)-1,1-biphenyl-4,4′-diamine (M-TBD), 7 grams of N,N′bis(1,2-dimethylpropyl)-1,4,5,8-naphthalenetetracarboxylic diimide (NT DI, and 672 grams of tetrahydrofuram (THF) and 225 grams momochlorobenzene (MCB). This mixture, denoted as “CT” solution, was rolled in a glass bottle until the solids were dissolved, then 91.5 grams of the mixture was mixed with 6.7 grams of the above pigment dispersion to form a dispersion containing Type V hydroxy gallium phthalocyanine, poly(4,4′-diphenyl-1,1′-cyclohexane carbonate), N,N′-diphenyl-N,N′-bis(methylphenyl)-1,1-biphenyl-4,4′-diamine, and N,N′bis(1,2-dimethylpropyl)-1,4,5,8-naphthalenetetracarboxylic diimide in a solids weight ratio of (4:46:42:8), denoted as Dispersion 1, and a total solid contents of 18.8 percent. Another 91.5 grams of the mixture was mixed with 3.34 grams of the above pigment dispersion to form a dispersion containing Type V hydroxy gallium phthalocyanine, poly(4,4′-diphenyl-1,1′-cyclohexane carbonate), N,N′-diphenyl-N,N′-bis(methylphenyl)-1,1-biphenyl-4,4′-diamine, and N,N′bis(1,2-dimethylpropyl)-1,4,5,8-naphthalenetetracarboxylic diimide in a solids weight ratio of (2:48:40:10), denoted as Dispersion 2, and a total solid contents of 18.5 percent. Similarly, two other dispersions with Type V hydroxy gallium phthalocyanine, poly(4,4′-diphenyl-1,1′-cyclohexane carbonate), N,N′-diphenyl-N,N′-bis(methylphenyl)-1,1-biphenyl-4,4′-diamine, and N,N′bis(1,2-dimethylpropyl)-1,4,5,8-naphthalenetetracarboxylic diimide in solids weight ratios of (0.5:52:42.5:5) and (1:52:42:5), denoted as Dispersions 3 and 4, respectively, were prepared. Dispersions 1 and 2 were also prepared at a higher solid content of 22.4 weight percent and are denoted as Control Solutions 1 and 2, respectively. Table 1 shows the solutions used in this example.

TABLE 1
Representative dispersions/solutions used in this invention.

| | HOGaPC | | | | | THF:MCB (in |
|---|---|---|---|---|---|---|
| Dispersion | (wt %) | PCZ-500 (wt %) | mTBD (wt %) | NTDI (wt %) | Solid wt % | weight) |
| 1 | 4 | 46 | 42 | 8 | 18.8 | 80:20 |
| 2 | 2 | 48 | 40 | 10 | 18.5 | 80:20 |
| 3 | 0.5 | 52 | 42.5 | 5 | 18.8 | 80:20 |
| 4 | 1 | 52 | 42 | 5 | 18.8 | 80:20 |
| Control | | | | | | |
| Solution 1 | 4 | 46 | 42 | 8 | 22.4 | 80:20 |
| Control | | | | | | |
| Solution 2 | 2 | 48 | 40 | 10 | 22.4 | 80:20 |
| CT | 0 | 60 (PCZ-400) | 40 | 0 | 21.8 | 75:25 |

Differential composite photoreceptors were prepared by sequential coating of one of the dispersions then another dispersion, which was then dried at 135 degrees Celsius for 45 minutes after the second layer was coated. A typical dip coating rate of 150 mm/min for one of the two layers would result in a dry layer thickness of about 12-18 micrometers. A number of devices have been fabricated and two examples, along with four comparative samples are shown in Table 2 to illustrate the practice of the invention. A composite photoreceptor is denoted as Bottom-Layer|Top-Layer.

TABLE 2
Representative devices and their respected electrical
performance. A composite photoreceptor is denoted as
Bottom-Layer/Top-Layer

| | | | | Dark Decay |
|---|---|---|---|---|
| | | | | (voltage |
| | -dV/dX¹ at an | | Surface | reduction |
| | initial surface | Surface Potentials at | Potentials at 20 | measured at |
| | potential of ca | 3.5 ergs/cm² light | ergs/cm² light | 51 ms after |
| Device | 900 V | exposure | exposure | charging) |
| 1: Disp 2 (15 μm)\|Disp. 1 | 422 | 98 | 75 | 78 |
| (15 μm) | | | | |
| 2: Disp. 3 (15 μm)\|Disp. 1 | 410 | 101 | 80 | 72 |
| (15 μm) | | | | |
| 3: CT (14 μm)\|Disp. 1(15 | 350 | 110 | 90 | 80 |
| μm) | | | | |
| 4: CT (14 μm)\|Disp. 2 (15 | 330 | 120 | 95 | 70 |
| μm) | | | | |
| 5: Control 1 (28 μm) | 420 | 105 | 87 | 130 |
| 6: Control 2 (27 μm) | 412 | 107 | 89 | 115 |

¹Photosensitivity of a photoinduced discharge curve defined as the slope of surface potential (in units of V) versus light exposure (in units of ergs/cm²) at the initial surface potential.

Other embodiments and modifications of the present invention may occur to those skilled in the art subsequent to a review of the information presented herein; these embodiments and modifications, equivalents thereof, substantial equivalents thereof, or similar equivalents thereof are also included within the scope of this invention.

What is claimed is:

1. A photoconductive imaging member comprised of a supporting substrate, and thereover a first and a second layer comprising both charge generation and charge transport materials and wherein the first layer contains a greater concentration of photo-electrically active pigments than the second layer.

2. An imaging member in accordance with claim 1 wherein said first and second layers are of a thickness of from about 5 to about 60 microns.

3. An imaging member in accordance with claim 1 wherein the amounts for each of said components in said first and second layer is from about 0.05 weight percent to about 30 weight percent for the photogenerating component, from about 10 weight percent to about 75 weight percent for the charge transport component, and from about 10 weight percent to about 75 weight percent for the electron transport component, and wherein the total of said components is about 100 percent, and wherein said layer components are dispersed in from about 10 weight percent to about 75 weight percent of said polymer binder, and wherein said layer is of a thickness of from about 5 to about 15 microns.

4. An imaging member in accordance with claim 1 wherein the amounts for each of said components in the first and second layer mixture is from about 0.5 weight percent to about 5 weight percent for the photogenerating component; from about 30 weight percent to about 50 weight percent for the charge transport component; and from about 5 weight percent to about 30 weight percent for the electron transport component; and which components are contained in from about 30 weight percent to about 50 weight percent of a polymer binder.

5. An imaging member in accordance with claim 1 wherein the thickness of said first and second layer is from about 5 to about 35 microns.

6. An imaging member in accordance with claim 1 wherein said first and second layer components are dispersed in said polymer binder, and wherein said charge transport is comprised of hole transport molecules.

7. An imaging member in accordance with claim 6 wherein said binder is present in an amount of from about 50 to about 90 percent by weight, and wherein the total of all components of said photogenerating component, said charge transport component, said binder, and said electron transport component is about 100 percent.

8. An imaging member in accordance with claim 1 wherein said photogenerating component absorbs light of a wavelength of from about 370 to about 950 nanometers.

9. An imaging member in accordance with claim 6 wherein the binder is selected from the group consisting of polyesters, polyvinyl butyrals, polycarbonates, polystyrene-b-polyvinyl pyridine, and polyvinyl formulas.

10. An imaging member in accordance with claim 1 wherein said charge transport component comprises aryl amine molecules.

11. An imaging member in accordance with claim 1 wherein said charge transporting component or components is comprised of molecules of the formula 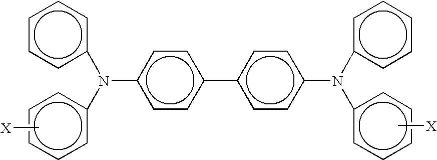
wherein X is selected from the group consisting of alkyl and halogen.

12. An imaging member in accordance with claim 11 wherein alkyl contains from about 1 to about 10 carbon atoms, and wherein the charge transport is an aryl amine encompassed by said formula and which amine is optionally dispersed in a resinous binder.

13. An imaging member in accordance with claim 11 wherein alkyl contains from 1 to about 5 carbon atoms.

14. An imaging member in accordance with claim 11 wherein alkyl is methyl, and wherein halogen is chloride.

15. An imaging member in accordance with claim 11 wherein said charge transport is comprised of N,N′bis(1,2-dimethyl propyl)-1,4,5,8-naphthalenetetracarboxylic diimide, N,N′-diphenyl-N,N-bis(3-methyl phenyl)-1,1′-biphenyl-4,4′-diamine, 9-9-bis(2-cyanoethyl)-2, 7-bis(phenyl-m-tolylamino)fluorene, tritolylamine, hydrazone, or N,N′-bis(3,4 dimethylphenyl)-N″(1-biphenyl) amine

16. An imaging member in accordance with claim 11 wherein said charge transport is comprised of molecules of N,N′-diphenyl-N,N-bis(3-methyl phenyl)-1,1′-biphenyl-4,4′-diamine.

17. An imaging member in accordance with claim 1 wherein said electron transport component is (4-n-butoxycarbonyl-9-fluorenylidene) malononitrile, 2-methylthioethyl 9-dicyanomethylenefluorene-4-carboxylate, 2-(3-thienyl)ethyl 9-dicyanomethylene fluorene-4-carboxylate, 2-phenylthioethyl 9-dicyanomethylenefluorene-4-carboxylate, 11,11,12,12-tetracyano anthraquinodimethane or 1,3-dimethyl-10-(dicyanomethylene)-anthrone.

18. An imaging member in accordance with claim 1 wherein said electron transport component is (4-n-butoxycarbonyl-9-fluorenylidene)malononitrile.

19. An imaging member in accordance with claim 11 wherein said electron transport component is (4-n-butoxycarbonyl-9-fluorenylidene)malononitrile, 2-methylthioethyl 9-dicyanomethylenefluorene-4-carboxylate, 2-(3-thienyl)ethyl 9-dicyanomethylenefluorene-4-carboxylate, 2-phenylthioethyl 9-dicyanomethylenefluorene-4-carboxylate, 11,11,12,12-tetracyano anthraquinodimethane or 1,3-dimethyl-10-(dicyanomethylene)-anthrone.

20. An imaging member in accordance with claim 1 wherein said electron transport is (4-n-butoxy carbonyl-9-fluorenylidene)malononitrile, and the charge transport is a hole transport of N,N′-diphenyl-N,N-bis(3-methyl phenyl)-1,1′-biphenyl-4,4″-diamine molecules.

21. A photoconductive imaging member comprised of a mixture containing a photogenerating component, hole transport molecules and an electron transport component, and thereover in contact with said first layer a second layer comprised of hole transport molecules dispersed in a resin binder and wherein the first layer has a greater photo-electrically active pigment concentration than the second layer.

22. A method of imaging which comprises generating an electrostatic latent image on the imaging member of claim 1, developing the latent image, and transferring the developed electrostatic image to a suitable substrate.

23. An imaging member in accordance with claim 1 wherein said member comprises, in sequence, a supporting layer, and a first and second layer, the electrophotographic photoconductive insulating layer comprising particles comprising a photogenerating pigment dispersed in a matrix comprising an arylamine hole transporter, and an electron transporter selected from the group consisting of a carboxlfluorenone malonitrile (CFM) derivatives represented by: 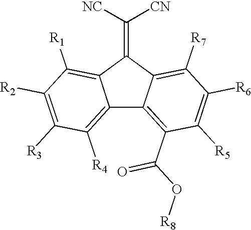
wherein each R is independently selected from the group consisting of hydrogen, alkyl having from about 1 to about 40 carbon atoms, alkoxy having from about 1 to about 40 carbon atoms, phenyl, substituted phenyl, naphthalene, antracene, alkylphenyl having from about 6 to about 40 carbons, alkoxyphenyl having from about 6 to about 40 carbons, aryl having from about 6 to about 30 carbons, substituted aryl having from about 6 to about 30 carbons and halogen,
or a nitrated fluoreneone derivative represented by: 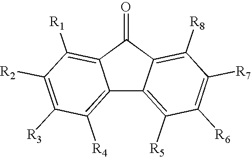
wherein each R is independently selected from the group consisting of hydrogen, alkyl having from about 1 to about 40 carbon atoms, alkoxy having from about 1 to about 0 carbon atoms, phenyl, substituted phenyl, naphthalene, antracene, alkylphenyl having from about 6 to about 40 carbons, alkoxyphenyl having from about 6 to about 40 carbons, aryl having from about 6 to about 30 carbons, substituted aryl having from about 6 to about 30 carbons and halogen, and at least 2 R groups are chosen to be nitro groups,
or a N,N′bis(dialkyl)-1,4,5,8-naphthalenetetracarboxylic diimide derivative or N,N′bis(diaryl)-1,4,5,8-naphthalenetetracarboxylic diimide derivative represented by: 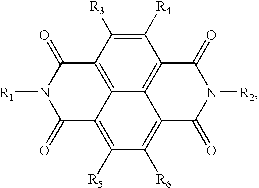
wherein R1 is substituted or unsubstituted alkyl, branched alkyl, cycloalkyl, alkoxy or aryl, phenyl, naphthyl, anthracene R2 is alkyl, branched alkyl, cycloalkyl, or aryl, phenyl, naphthyl, or anthracene or the same as R1; R1 and R2 can be chosen independently to have total carbon number from about 1 to about 50. R3, R4, R5 and R6 are alkyl, branched alkyl, cycloalkyl, alkoxy or aryl, phenyl, naphthyl, anthracene or halogen. R3, R4, R5 and R6 can be the same or different. In the case were R3, R4, R5 and R6 are carbon, they can be chosen independently to have a total carbon number from about 1 to about 50,
or a 1,1′-dioxo-2-(aryl)-6-phenyl-4-(dicyanomethylidene)thiopyran derivative represented by: 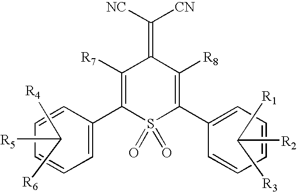
wherein each R is independently selected from the group consisting of hydrogen, alkyl having from about 1 to about 40 carbon atoms, alkoxy having from about 1 to about 40 carbon atoms, phenyl, substituted phenyl, naphthalene, antracene, alkylphenyl having from about 6 to about 40 carbons, alkoxyphenyl having from about 6 to about 40 carbons, aryl having from about 6 to about 30 carbons, substituted aryl having from about 6 to about 30 carbons and halogen,
or a
carboxybenzylnaphthaquinone derivative represented by: 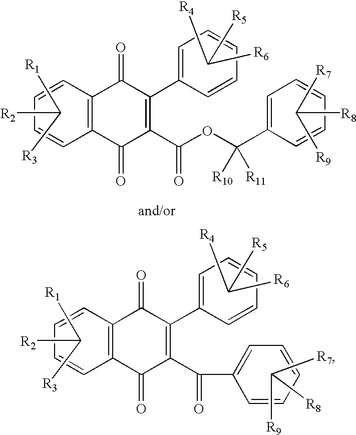
wherein each R is independently selected from the group consisting of hydrogen, alkyl having from about 1 to about 40 carbon atoms, alkoxy having from about 1 to about 40 carbon atoms, phenyl, substituted phenyl, naphthalene, antracene, alkylphenyl having from about 6 to about 40 carbons, alkoxyphenyl having from about 6 to about 40 carbons, aryl having from about 6 to about 30 carbons, substituted aryl having from about 6 to about 30 carbons and halogen,
or a diphenoquinone represented by: 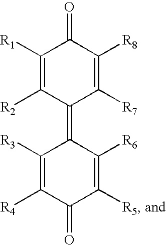
mixtures thereof, wherein each R is independently selected from the group consisting of hydrogen, alkyl having from about 1 to about 40 carbon atoms, alkoxy having from about 1 to about 40 carbon atoms, phenyl, substituted phenyl, naphthalene, antracene, alkylphenyl having from about 6 to about 40 carbons, alkoxyphenyl having from about 6 to about 40 carbons, aryl having from about 6 to about 30 carbons, substituted aryl having from about 6 to about 30 carbons and halogen, and a film forming binder.

24. An imaging member in accordance with claim 23 wherein the arylamine is N,N′-diphenyl-N,N′-bis(3-methylphenyl)-[1,1′-biphenyl]-4,4′-diamine.

25. An imaging member in accordance with claim 23 wherein the film forming binder is a polycarbonate.

26. An imaging member in accordance with claim 1 wherein the first and second layer components are dispersed in a binder selected from the group consisting of polycarbonates, polystyrene-b-polyvinyl pyridine, N,N′-diphenyl-N,N′-bis(alkylphenyl)-1,1-biphenyl-4,4′-diamine; TTA, tri-p-tolylamine; AE-18, N,N′-bis-(3,4,-dimethylphenyl)-4-biphenyl amine; AB-16, N,N′-bis-(4-methylphenyl)-N, N″-bis(4-ethylphenyl)-1,1′-3,3′-dimethylbiphenyl)-4,4′-diamine; and PHN, phenanthrene diamine; and 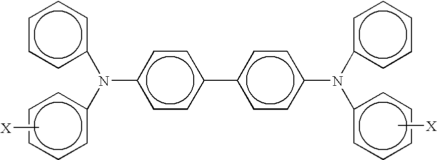
wherein the charge transport comprises aryl amine molecules of the formula wherein X is selected from the group consisting of alkyl and halogen.

27. A photoconductive imaging member comprised of a supporting substrate, and thereover a first and a second layer comprised of a mixture of a photogenerator component, a charge transport component, an electron transport component, and a polymer binder, and wherein the first layer has a higher pigment concentration than that of the second layer.
